(19) United States
(12) Patent Application Publication
(10) Pub. No.: US 2008/0260330 A1
(43) Pub. Date: Oct. 23, 2008

(54) ALIGNMENT WITH THIN BONDING LAYER OF OPTICAL COMPONENTS

(75) Inventors: Alex Rosiewicz, Stow, MA (US); Ninghui Zhu, Winchester, MA (US)

Correspondence Address: WILMERHALE/BOSTON, 60 STATE STREET, BOSTON, MA, 02109, US

(73) Assignee: EM4, Inc.

(21) Appl. No.: 11/737,580

(22) Filed: Apr. 19, 2007

(51) Int. Cl. G02B 6/32; G02B 6/26

(52) U.S. Cl. 385/33; 385/31

(57) ABSTRACT

An optical component is attached to a mounting block and the mounting block is attached to a carrier. The optical component is actively aligned by adjusting the optical component with respect to the mounting block and the mounting block with respect to the carrier. An adhesive used for the attachments can be in a layer of 5 microns or less to reduce thermal degradation and effects of thermal expansion.

### BACKGROUND

It is desirable for systems having multiple optical components to have those components accurately aligned. For example, systems in which laser light is introduced into an optical fiber for telecommunications purposes often have one lens that collimates the laser light and another lens that focuses the laser light onto the tip of the fiber. To improve the amount of laser light that is coupled to the fiber, the optical components should be accurately aligned with the laser and the fiber tip.

Accurate alignment is desirable not only during the manufacture of optical systems when the components are first assembled and secured, but also during the lifetime of the optical system. Alignment can degrade during the lifetime. Adhesive layers that bond optical components in place can shrink or crack over time causing optical components to drift out of alignment. Also, adhesives, such as epoxy or solder, can have thermal expansion rates that are different from those other components in an optical system. When the system is subject to thermal fluctuations, expansion and contraction causes differential movement between optical components that are secured by adhesive and other components of the system.

### SUMMARY

The described system and method for accurate alignment of optical components in a system yield an alignment that can be less susceptible to degradation that results from changes occurring within the adhesive from the effects of thermal fluctuations.

A mounting block is attached to a carrier with thin layers of adhesive material, and an optical component is mounted to the block also using thin layers of adhesive. The component mounted to the block and the mount block mounted to the carrier are adjusted along three coordinate axes to provide alignment in an optical system. Additional blocks and components can also be provided. The mounting blocks can be used to align a lens in a system that includes a laser and an optical fiber, or in other systems with optical components. The adhesive that is used can be a solder or a sol-gel, or any other suitable adhesive. It is desired that after attachment, the layers of adhesive have a combined thickness of about 5 microns or less. Such thin layers of adhesive, while not strictly necessary, are advantageous because they can reduce the degradation in the optical alignment that commonly occurs when thicker adhesive layers are used.

The systems and methods described here are thus useful for aligning components in a way that is more accurate at the time of alignment and that stays in accurate alignment over time. Other features and advantages will become apparent from the following detailed description, drawings, and claims.

### BRIEF DESCRIPTION OF THE DRAWINGS

FIG. 1 is a perspective drawing of an alignment system.

FIG. 2 is a set of perspective views of components of an alignment system.

FIG. 3 illustrates an embodiment that uses a non-solder adhesive.

FIG. 4 is a perspective view illustrating the coupling of a light source to a fiber optic system with an alignment system.

### DETAILED DESCRIPTION

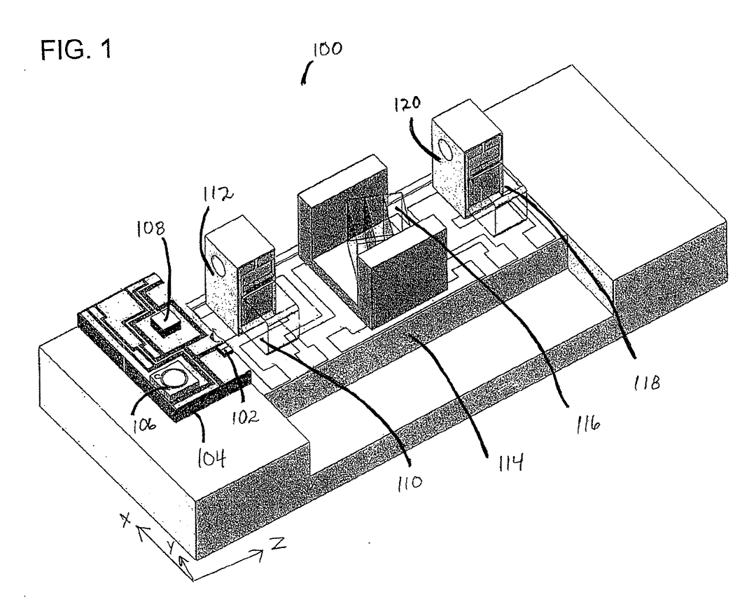

FIG. 1 illustrates a system for coupling a laser to an optical fiber in which the optical components are aligned in accordance with the described embodiment. Laser 102, mounted on substrate 104, provides laser light. If the system is used for telecommunications, a distributed feedback (DFB) laser is typically also deployed. Also on the substrate with the laser, photodetector 106 monitors the laser output. A thermistor 108 measures the substrate's temperature and ensures that the temperature does not get high enough to risk damaging system components.

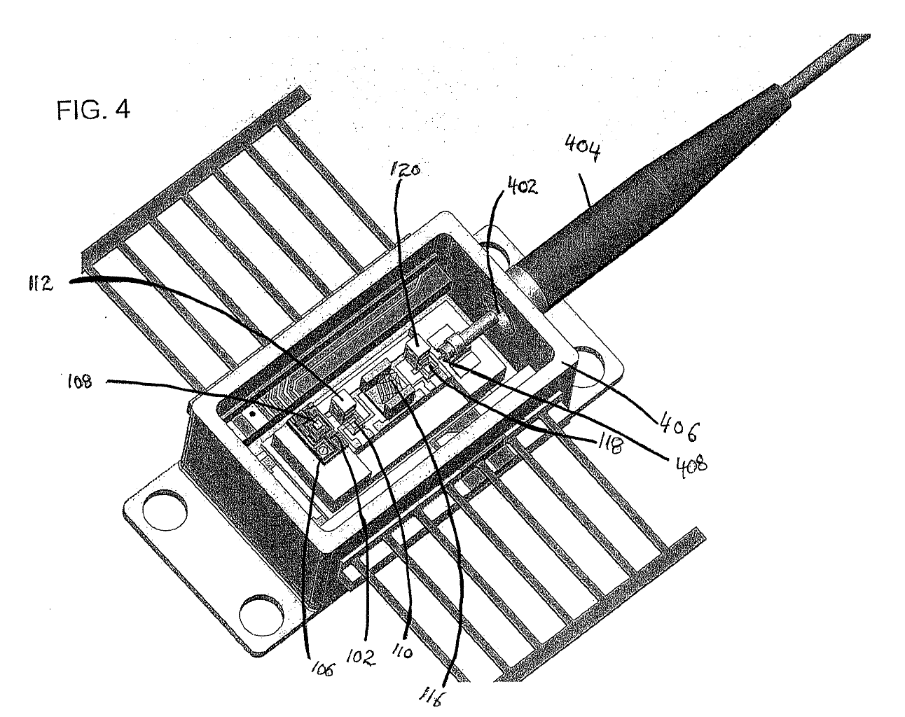

Laser 102 provides a laser beam that passes through collimating lens 110. Commercially available square lens 110, as manufactured, for example, by ALPS Electric Co., Ltd. or by Lightpath Technologies, Inc., is affixed to lens mounting block 112, which is itself mounted onto main carrier 114 that is typically made of ceramic. The laser beam next passes through surface mounted isolator 116, and then through second lens 118 that focuses the beam onto a tip of an optical fiber (see FIG. 4). Lens 118 is attached to lens mounting block 120.

The three orthogonal coordinate axes referred to in what follows are shown at bottom left in FIG. 1. Lens 110 is aligned along the two orthogonal directions, i.e., the x-axis and z-axis, in the plane of substrate 114 by adjusting the position of mounting block 112 on substrate 114. Fine-scale adjustments of block 112 on substrate 114 are conducted by moving the mounting block. Adjustments in a direction perpendicular to the substrate, i.e., along the y-axis, are made by sliding lens 110 up and down along mounting block 112. Some adjustment along the z-axis is also possible by moving lens 110 with respect to mounting block 112. The lens is also aligned by performing angular adjustments about the x- and y-axes, i.e., azimuthally about the x- and y-axes.

A desired position is determined by active alignment. The amount of power coupled to the fiber is monitored, and the alignment is set at the position where the coupled power is at a high level, often at a maximum. A controller (not shown) receives the power coupled to the fiber and provides feedback to the adjustment process. This process may be either manual or robotic depending upon the required degree of accuracy and repeatability and the required volume of throughput.

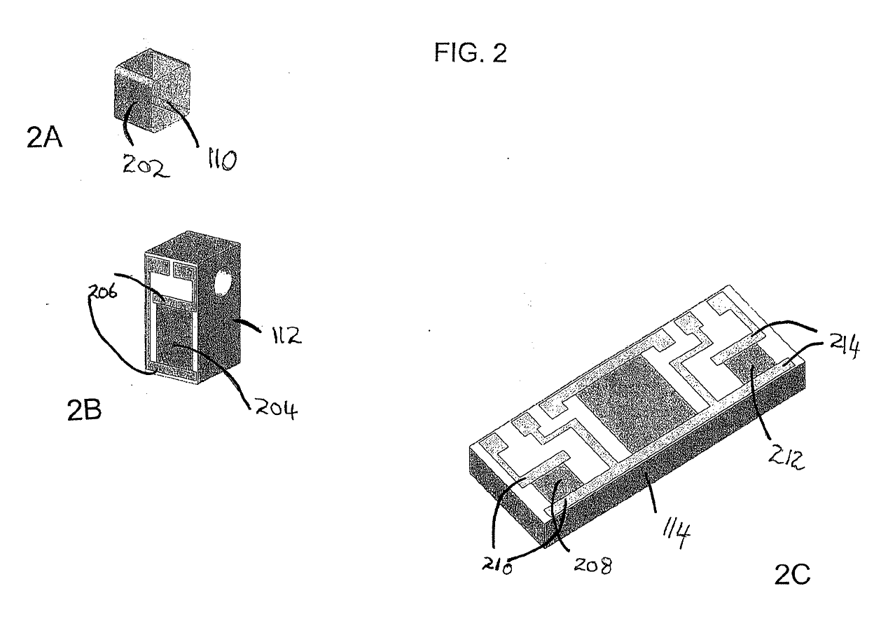

FIG. 2A illustrates lens 110 and shows its metallized side 202. As shown in FIG. 2B, lens adjusting and mounting block 112 is covered with thin layer of solder 204 on one side. Solder 204 is melted by passing current through electrodes 206, and lens 202 is then attached to mounting block 112 with this thin solder layer. In one embodiment, the bonding layer of solder after attachment is less than or equal to about 5 microns. As shown in FIG. 2C, lens mounting block 112 is attached to main ceramic carrier 114 with a solder layer 208, also having a thickness of about 5 microns or less. Solder layer 208 is melted by passing current through electrodes 210. After alignment, solder layers 204 and 208 are allowed to solidify. Similar alignment steps can be performed for lens 118 (see FIG. 1) with mounting block 120, solder layer 212, and electrodes 214 (FIG. 2C).

One useful aspect of the described embodiment is the low thickness, i.e., less than or equal to about 5 microns, of the solder layer that secures the optical components in place. The thin bond layer enables a more precise alignment to be performed than would be possible with a thicker layer because there is less ability for shrinkage and misalignment during the fixing process. A thin bond layer is also expected to have less susceptibility to drift or cracking over time than would thicker layers of adhesive. Thus a thin bond line can maintain optimal alignment longer than systems with thicker adhesive layers. A thin bond layer is also less susceptible to thermal creep, because any differential expansion of the bond compared to the surrounding components is kept to a minimum. Furthermore, with a thin bond layer there is less opportunity for significant variation in bond thickness across a given bond. An advantage of such a uniform thickness bond layer is that temperature variations cause the bond line to shrink or expand uniformly, with the bonded surfaces remaining parallel, thus avoiding undesirable angular translation.

In another embodiment, a thin layer of chemical adhesive, such as a sol-gel, secures the optical components in place.

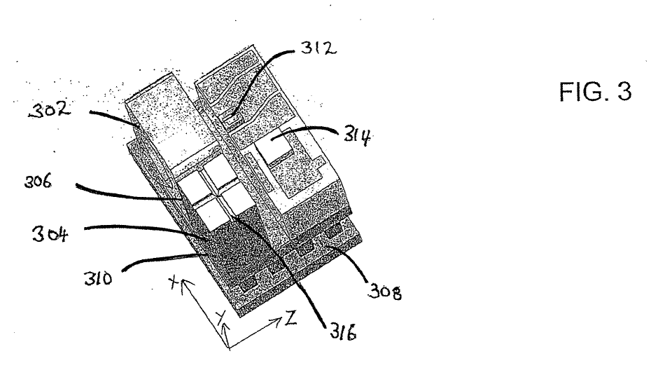

Referring to FIG. 3, lens 302 adheres to mounting block 304 with a thin adhesive layer coating surfaces of lens 302 and mounting block 304 along junction 306. Mounting block 304 adheres to ceramic carrier 308 with a second layer of an adhesive that coats junction 310 between block 304 and carrier 308. The beam of DFB laser 312 passes through lens 302 to a target (not shown), such as an optical fiber tip. Photodetector 314 monitors the output of laser 312. As discussed above for the solder embodiment, the coupling of the laser to the target is actively monitored during alignment. The two axes in the plane of the carrier, i.e., the x- and y-axes, are aligned by moving block 304 with respect to carrier 308. The third axis, i.e., the z-axis, is aligned by moving lens 302 with respect to block 304 along an axis substantially perpendicular to the carrier. Grooves 316 at the top of block 304 facilitate fine scale x-axis and z-axis adjustment with a Philips head screwdriver while lens 302 is held and adjusted along the y-axis with a vacuum chuck. Chemical adhesives, such as sol-gel, do not require electrodes for electric heating and melting, enabling a simpler carrier and mounting block design.

FIG. 4 shows an application of the alignment methods and systems described above to align a laser with an optical fiber. Fiber 402 in protective sheath 404 is welded into place into package 406. The components shown in FIG. 1, including laser 102, photodetector 106, thermistor 108, collimating lens 110, mounting block 112, surface mounted isolator 116, focusing lens 118, and mounting block 120, are all contained within package 406. The alignment is performed to maximize the coupling of a laser beam from laser 102 to fiber optic tip 408.

Other embodiments are within the scope of the following claims. For example, the description relates to optical lasers, lenses, and fibers, although the alignment concepts can be employed with other optical components. Although the described embodiment shows the alignment of square lenses, lenses having any shape may be aligned using the disclosed methods and systems. The optical components to be aligned are not limited to lenses, but may include mirrors, prisms and diffraction gratings. In addition to the solder and sol-gel adhesive layers, other adhesives may be used such as epoxy and UV curing epoxy. Adhesives having a low coefficient of thermal expansion are preferred. However, using adhesives in thin films as described above minimizes the effect of thermal expansion, thereby relaxing the requirement for a low coefficient of thermal expansion.

What is claimed is:

1. A method of aligning a plurality of optical components within an optical system, the method comprising:
attaching a first mounting block to a carrier using a first thin layer of adhesive material on a first surface of the first mounting block and a second thin layer of adhesive material on a corresponding portion of a second surface of the carrier;
attaching a first optical component to the first mounting block using a third thin layer of adhesive material on a third surface of the optical component, wherein the third surface is substantially perpendicular to a plane of the carrier, and a fourth thin layer of adhesive material on a corresponding portion of a fourth surface of the first mounting block; and
actively aligning the first optical component by adjusting the position of the first mounting block in the plane of the carrier by positioning the mounting block on the carrier and adjusting the position of the first optical component in a direction perpendicular to the plane of the carrier by positioning the optical component with respect to the first mounting block.

2. The method of claim 1, wherein the optical alignment is determined by the position of the optical component that maximizes the coupling of a light source passing through one or more optical components to a target.

3. The method of claim 1, wherein the adhesive material comprises solder.

4. The method of claim 1 wherein the solder is heated prior to alignment by passing an electrical current though the solder.

5. The method of claim 1, wherein the adhesive material includes sol-gel.

6. The method of claim 1, wherein, after attachment, the first and second layers of adhesive material have a combined thickness of 5 microns or less.

7. The method of claim 5, wherein the third and fourth layers of adhesive material have a combined thickness of about 5 microns or less.

8. The method of claim 1, wherein the third and fourth layers of adhesive material have a combined thickness of about 5 microns or less.

9. The method of claim 1, wherein the first optical component includes one of the set consisting of a lens, a mirror, a prism, and a diffraction grating.

10. The method of claim 1, further comprising attaching a second optical component to a second mounting block and the second mounting block to the carrier in a manner substantially the same as the attachment of the first optical component to the first mounting block and the first mounting block to the carrier.

11. The method of claim 1, wherein each of the plurality of optical components includes one of the set consisting of a lens, a mirror, a prism, and a diffraction grating.
